(19) United States
(12) Patent Application Publication
(10) Pub. No.: US 2008/0287116 A1
(43) Pub. Date: Nov. 20, 2008

(54) Radio Mobile Unit Location System

(75) Inventors: Christopher R. Drane, New South Wales (AU); Malcolm D. Macnaughtan, New South Wales (AU)

Correspondence Address: JONES DAY, 222 EAST 41ST ST, NEW YORK, NY, 10017, US

(73) Assignee: Seeker Wireless Pty Limited, Pymble, New South Wales (AU)

(21) Appl. No.: 11/662,203

(22) PCT Filed: Sep. 7, 2005
(86) PCT No.: PCT/AU05/01358

§ 371 Date: May 19, 2008

(30) Foreign Application Priority Data
Sep. 7, 2004 (AU) 2004905077

(51) Int. Cl. H04Q 7/20

(52) U.S. Cl. 455/423; 455/436

(57) ABSTRACT

Disclosed is a method for locating a mobile radio unit within a mobile radio communications network. The method provides for the calculation of network variables such as a Real Time Difference (RTD) between network elements, from measurements already available to the network from, for example, handovers between network elements. The method provides for the location of radio mobile units without having to synchronise network elements such as BTSs or LMUs.

### TECHNICAL FIELD

This invention relates to methods and apparatus for locating a mobile radio unit within a radio communications network and to calculating various network parameters that may be used in locating the mobile radio unit.

### BACKGROUND TO THE INVENTION

Existing cellular location systems can be classified according to the type of measurement that they employ to determine a handset's position.
Cell ID (CID)
Signal strength
Angle of Arrival (AOA)
Time of Arrival (TOA) or Time Difference of Arrival (TDOA)

Of these, time arrival based systems have been shown to offer the greatest accuracy. Examples of such systems include A-GPS, U-TDOA and E-OTD. All time of arrival based systems however, suffer from the disadvantage that certain geographically dispersed elements within the cellular network must be synchronised, or pseudo-synchronised.

In the case of E-OTD for instance, it is the Base Stations that need to be synchronised in order to derive positional information from the OTDs reported by the handset. (In actual fact in E-OTD the base stations are pseudo-synchronised in the sense that a table of offsets is maintained, rather than actually having their clocks aligned to be in synchrony). On the other hand in U-TDOA systems, it is the Location Measurement Units responsible for measuring signals transmitted by the handset that require synchronisation and this is typically achieved through the use of GPS time transfer methods.

The measures taken to provide this synchronisation are arguably the key determinant of system complexity and perhaps more importantly system cost. To illustrate using E-OTD, the key components of a system are (1) a minimal software module in the handset(s), (2) a Serving Mobile Location Centre (SMLC) to perform the pseudo synchronisation and location calculations and (3) Location Measurement Units (LMUs) deployed throughout the network coverage area to measure the relative time offsets between the BTSs. In the case of E-OTD, this requirement to deploy LMUs has been perhaps the greatest hurdle to the commercial success of the technology.

Faced with an uncertain demand for LBS and therefore unwilling to commit to the high cost of deployment of E-OTD operators have tended to pursue low cost systems using either CID or Signal Strength methods. However in this case the performance of these systems has been a significant limitation, precluding the deployment of some services and limiting the usefulness of those services that are able to be offered.

### SUMMARY OF THE INVENTION

According to a first aspect of the present invention, there is provided a method of determining a Real Time Difference (RTD) between respective clocks of a first network element and a second network element in a communications network, the method comprising:
measuring at least one parameter resulting from a first handover of a first mobile unit from the first network element to the second network element to provide a first measurement set;
measuring the at least one parameter resulting from a handover of at least one further mobile unit between the first network element and the second network element to provide a further measurement set; and
processing the first and further measurement sets to provide an estimate of a common RTD.

Preferably the first mobile unit and the further mobile unit are at different positions within the communications network.

Preferably, the at least one parameter is an Observed Time Difference (OTD) and/or a Timing Advance (TA).

Preferably, the first network element and the second network element are base transmitting stations (BTS).

Preferably, the first and further measurement sets are processed by averaging.

Optionally, the step of averaging comprises filtering the first and further measurement sets according to the formula:

$$R T {D}_{ij}^{′} = \frac{1}{n} {\sum }_{k = 1}^{n} R T {D}_{ij} ( k )$$

where RTDᵢⱼ′ is the estimate of the common RTD between BTSᵢ and BTSⱼ obtained by taking the numerical average of the previous n common RTD measurements denoted RTDᵢⱼ(k), and
i=an i^{th} sector, j=a j^{th} sector

Alternatively, the step of averaging comprises filtering the first and further measurement sets according to the recursive formula:

$$R T {D}_{ij}^{′} ( k ) = \frac{1}{k} ( R T {D}_{ij} ( k ) + ( k - 1 ) R T {D}_{ij}^{′} ( k - 1 ) )$$

Preferably, measurements of the at least one parameter from handovers occurring between co-sited sectors are analysed to determine whether the co-sited sectors derive their timing from a common source.

Preferably, the measurements from the handovers occurring between co-sited sectors which have been determined to derive their timing from a common source are processed to provide the common RTD.

Preferably, the step of averaging is performed by use of a filter having a time constant.

Preferably, the time constant of the filter is determined by a rate of drift of a clock of the first or second network element.

Preferably, the filter is a Kalman filter.

According to a second aspect of the present invention, there is provided a method of averaging a plurality of RTD measurements taken in respect of a communications network clocked element which experiences clock drift, the method comprising:
averaging the plurality of RTD measurements over a given period of time.

Preferably, the given period of time is determined by a rate and/or the linearity of the clock drift of the clocked element.

Preferably, the plurality of RTD measurements is averaged by use of a filter having a time constant.

Preferably, the time constant of the filter is proportional to the rate and/or the linearity of clock drift.

Even more preferably, the time constant is proportional to a maximum tolerable synchronisation error divided by the differential clock drift between the clocked element and that of a second clocked element in the network.

Preferably, RTD measurements taken towards the beginning of the given period of time are given progressively less weighting than RTD measurements taken towards the end of the given period of time.

Preferably, the filter is an exponential filter operating according to the following formula:

RTDᵢⱼ′(k)=αRTDᵢⱼ(k)+(1−α)RTDᵢⱼ′(k−1)

where RTD′ᵢⱼ(k) is the filtered estimate of the RTD between BTSᵢ and BTSⱼ at time k
RTDᵢⱼ(k) is the computed RTD between BTSᵢ and BTSⱼ at time k and α is the filter parameter determining the time constant of the filter.

Preferably, the averaging is performed by a Kalman filter.

According to a third aspect of the present invention, there is provided a method of calculating a real time difference (RTD) between respective clocks of a first network element and a second network element within a radio communications network, the method comprising:
estimating a position of a mobile element within the network to provide an estimated mobile element position;
calculating a distance (d₁) between the first network element and the estimated mobile element position;
calculating a distance (d₂) between the second network element and the estimated mobile element position;

measuring an Observed Time Difference (OTD_{1,2}) between the respective clocks of the first and second network elements; and
calculating the RTD according to the following formula:

RTD_{1,2}=OTD_{1,2}−d₁+d₂

Preferably, the step of estimating the position of the mobile element is performed using Cell ID.

Preferably, the step of estimating the position of the mobile element is performed using a Global Positioning System (GPS).

Preferably, the network elements are Base Transmitting Stations (BTS) and the mobile element is a mobile telephone handset.

According to a fourth aspect of the present invention, there is provided a method of calculating a Real Time Difference (RTD) between respective clocks of a first network element and a second network element within a radio communications network, the method including;
estimating a position of a mobile element handing over from the first network element to the second network element, using a current value of the RTD found by the network;
estimating a subsequent RTD using the estimated position of the mobile element;
processing the subsequent RTD according to the first aspect of the present invention and using the processed subsequent RTD to again estimate the position of the mobile element; and
repeating the process for as many cycles as is required.

Optionally, the initial RTD value used is calculated using the estimated position of the mobile element derived from Timing Advance plus NMR values in place of the current RTD held by the network.

According to a sixth aspect of the present invention, there is provided a method of determining the position of a mobile unit within a mobile radio communications network, the method including the use of an Observed Time Difference (OTD) in conjunction with two or more time of arrivals (TA) and a current RTD held by the network to derive a Geometric Time Difference (GTD) describing a hyperbolic locus of position.

According to a seventh aspect of the present invention, there is provided a method of estimating a position of a mobile unit between two network elements within a radio communications network, the method including:
measuring signal strength at the mobile unit to provide a first measurement;
obtaining a Timing Advance measurement at the mobile unit to provide a second measurement;
measuring an Observed Time Difference (OTD) between the two network elements at the mobile unit to provide a third measurement; and
combining and processing the three measurements to obtain an estimate of the position of the mobile unit.

Preferably, the OTD is obtained as the mobile unit is handing over from a first to a second of the two network elements.

Preferably, the network elements are BTSs.

The present invention accordingly provides a means to provide the pseudo-synchronisation for timing based positioning systems in cellular networks without incurring the high cost of LMU deployments. The resulting synchronisation is sufficiently accurate to support timing based positioning methods. This means that the greater accuracy of E-OTD type systems is available at the significantly lower cost and complexity of CID type systems.

Various parameters are calculated within a radio communications network which are useful in calculating several other parameters or quantities. For example, the parameter of Observed Time Difference (OTD) (which is a measure of the time difference between the clocks of two base stations as measured by a mobile unit being handed over between the two base stations) is useful in calculating the Real Time Difference, which is the actual amount of time offset between the two clocks. These in turn may be used in calculating the position of a mobile unit within the network. The inventions described in this application provide for improved means of calculating or obtaining these parameters, which can be used for mobile location, but also for other applications such as those that are position sensitive or that require more accurate time transfer to the mobile and therefore require a more accurate network-wide time reference. Accordingly, while the emphasis of the present application is to mobile unit location, it should not be so limited to this application.

### BRIEF DESCRIPTION OF THE DRAWINGS

FIG. 1—shows a Mobile Station (MS) handover between two base stations (BTS) to provide measurements for use in the present invention;

FIG. 2—shows a model for determining a typical number of handovers in a handover-based RTD network;

FIG. 3—shows the connectivity between BTSs in the environment of FIG. 2, in one simulated interval;

FIG. 4—shows the connectivity between pairs of sites in the network of FIG. 2;

FIG. 5—illustrates the use of a Geometric Time Difference (GTD) in estimating the position of a mobile unit; and

FIG. 6—shows the improvement in the cumulative distribution of the position error when using an OTD.

### DETAILED DESCRIPTION OF THE PREFERRED EMBODIMENT

The present discussion will use the GSM system to provide a concrete example but applies equally to GPRS and UMTS. The objective is to determine (without expensive LMU deployments) the relative time differences between a pair of clocked network elements such as BTSs. The time difference between BTSs is commonly referred to as the Real Time Difference (RTD). These time differences typically vary slowly over time, and therefore this is an ongoing process, the estimates have to be updated at appropriate intervals.

In the following description, there will be described a number of ways in which this synchronisation can be achieved. Networks differ in terms of the handset capabilities as well as the operator's preference for incorporating enhancements. The variety of ways presented herein enables an operator to select a technique that minimises the impact on the handsets and the network and their cost.

### Handover Based Synchronisation Using OTD and TAs

The basis of this method is the handover process whereby a handset that has an active connection to one BTS is handed over to another nearby BTS while the call is maintained. This is a feature of all mobile cellular networks. In GSM, the handover process concludes with the handset sending a handover complete message to the new BTS. This message may contain among other information, the observed time difference (OTD) at the handset between the initial and new BTS. Two additional pieces of information, which are readily available both at the handset and within the network, enable the handover OTD to be used to derive the corresponding RTD between the BTSs. These are the Timing Advance (TA) measurements relating to each of the BTSs respectively.

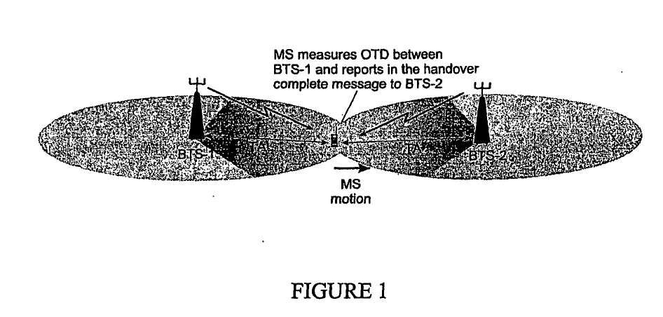

The range between the original BTS and the handset, represented in coarse fashion by the Timing Advance (TA) will have been measured whilst the handset was connected to that BTS. Similarly as part of the connection establishment with the new BTS, a second TA will have been measured providing a coarse indication of the range between the handset and the new BTS. FIG. 1 illustrates this situation.

The RTD between the original and the new BTS can now be estimated from these 3 observations as

RTDᵢⱼ−OTDᵢⱼ−TAᵢ+TAⱼ (1)

Where

OTDᵢⱼ=tᵢ−tⱼ (2)

and tᵢ is the time of arrival measured by the handset for the signal from BTSᵢ and TAᵢ is the Timing Advance value received by the handset from BTSᵢ. This calculation is currently used in standard GSM networks however, this information has not been employed for synchronisation to support mobile positioning. The reason for this is that the OTD and TA measurements from which the RTD estimate is to be derived are very imprecise. The handover OTD is measured by the handset and then rounded before reporting, to the nearest half bit (in positioning terms to the nearest multiple of 550 m). More significantly for the present purpose, the two TAs are rounded to the nearest bit (1100 m). Additionally because of the coarse quantisation that follows, the techniques used to make the actual timing measurements are typically imprecise, yielding large errors particularly in the presence of multipath (the specified accuracy is in fact +/−¾ bit, taking into account handset mobility. The result is a noisy measurement which is then quantised, adding significant additional quantisation noise.

Using these measurements to determine the RTD between the BTSs will therefore yield an estimate with an error of the order of a kilometre or worse. For a timing based positioning system, this level of RTD accuracy is of little interest because if used directly, the resulting position estimates would exhibit similar accuracies to the cheaper and simpler CID type systems. These measurements are accordingly considered to be unsuitable for positioning.

The following paragraphs will describe an improved method for deriving the timing differences between BTSs using the OTD and TA measurements discussed above. Beginning with the actual handover process, at the conclusion of the handover, the OTD value has been measured by the handset and reported to the network. Additionally TA measurements have been made originally by the first BTS and then subsequently by the final BTS.

These measurements although made by the respective BTSs, have been communicated to the handset. There is an implementation choice as to how to transfer this information to the positioning server. A number of options exist including sending the OTD and TAs from the handset to the server, by one or more available means including SMS and GPRS.

Another option is for the network to gather the data, compute the RTD and supply this to the server (the network already calculates the RTD in coarse fashion). In further alternatives for transferring the information of interest to the positioning server, the handset could use the three measurements to compute an RTD and then forward this to the server or the network could forward the OTD and TAs to the server rather than just the processed RTD. This is preferable to the former as the server can use the measurements taken individually to greater effect than simply the processed result.

Improving Accuracy by Averaging Multiple Handover Measurement Sets from Different Mobiles.

A first aspect of the present invention is based on the fact that in a given network, assuming a particular handset is handed over from BTS A to BTS B, it is likely that at the same or similar time, several other handsets will also be handed over in the same fashion.

According to this first aspect, by grouping the measurements arising from all of these handovers together and estimating the underlying common RTD between BTS A and BTS B, a more accurate estimate of the true RTD can be obtained.

There are two factors which work to yield an improved accuracy here. Firstly there is the simple gain due to averaging. Although at first it might appear that the gain would be small because of the relatively coarse quantisation, in fact the situation is somewhat better based on the following realisation by the inventors of the present application—because of the relatively high level of measurement noise in the individual measurements giving rise to the TA. As noted earlier, the accuracy requirements for the timing measurements are only ¾ of a bit. In addition, the combined effects of noise, interference and time dispersion in terrestrial mobile propagation mean that the error distribution of the basic time measurements exhibits heavy tails. The result is that notwithstanding the coarse quantisation bins, measurements will fall outside the nearest bin, providing greater information on the true underlying range. The same applies to the OTD measurement only to greater effect given the two times better resolution.

Improving the RTD estimates by averaging can be achieved via various filtering techniques. An example of such a technique is:

$$R T {D}_{ij}^{′} = \frac{1}{n} {\sum }_{k = 1}^{n} R T {D}_{ij} ( k ) \qquad ( 3 )$$

where RTDᵢⱼ′ is the estimate of the RTD obtained by taking the numerical average of the previous n RTD measurements denoted RTDᵢⱼ(k).

Another technique is the recursive equivalent of the same formula whereby the RTD estimate is continually improved by combining the previous estimate with the newest measurement.

$$R T {D}_{ij}^{′} ( k ) = \frac{1}{k} ( R T {D}_{ij} ( k ) + ( k - 1 ) R T {D}_{ij}^{′} ( k - 1 ) ) \qquad ( 4 )$$

The second factor yielding improvement is, again due to the realisation, that the collection of handover based OTD and TA measurements gathered over some time period will be associated with handsets in different physical locations (although typically all will be situated in the notional transition region between the two cells). The advantage here is that the quantisation errors in the TA measurements are a function of the actual range between the handset and the two BTSs involved in the handover. Therefore by combining several observations from different sites, the quantisation errors in each will differ and cancel to a degree. The same also applies to the OTD measurements reported by each handset because the actual OTD will depend on the relative distances to the BTSs and the relation of this value to the ½ bit quantisation boundaries.

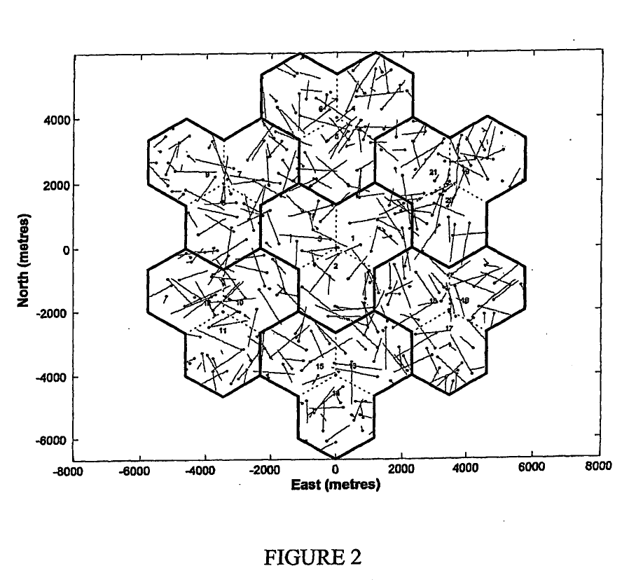

FIG. 2 shows a simple model used to investigate the number of handover measurements that might be available for averaging in a typical network. The network is assumed to be in a suburban environment with cells of radius 4 km. Each site is equipped with three sectors. A number of subscribers are placed randomly across each cell in the network and assigned random velocities ranging from stationary through pedestrian speeds and up to typical suburban vehicular speeds of 60 kmh. The movement of each subscriber over the duration of the simulation is shown in the figure. (For this simulation each subscriber is assumed to move with constant velocity for the duration). The number of subscribers per cell is based on an assumption of 3 GSM TRX per sector and a 70 percent utilisation factor. A wrap-around technique is applied to avoid boundary effects from the relatively small scale of the model used. The model is idealised in the sense that a handover only occurs when a subscriber crosses the coverage boundary of the current serving cell into a neighbouring cell. This underestimates the number of handovers because fading and interference in practical networks result in a greater number of handovers. The connectivity of the resulting RTD network is also limited by this assumption because mobiles are always handed between adjacent cells whereas the vagaries of mobile radio in practical networks means that this is not always the case. In any event, as shown below, the simulation illustrates the availability of multiple measurements for use in a typical network, enabling improvement by averaging.

A further factor with the averaging is that it is commonly assumed that the errors in the raw round trip time measurements are smaller in comparison with the rounding errors and therefore so heavily dominated by the rounding to the nearest bit that there is little information available from multiple observations of the TA. In practical networks however, especially in highly dispersive environments, making the delay estimation errors arising from multipath and Non Line of Sight when making the delay estimates that contribute to the TAs and OTD are likely to perturb the rounded TA sufficiently that there is benefit in accumulating and averaging multiple observations of the TA. This wider spread of the errors in practice means that multiple observations of the rounded TA value can be useful in deriving a more accurate estimate of the underlying true range. This is especially the case when a suitable model of the error distribution is applied.

### Improving Synchronisation Accuracy by Averaging Over the Longest Possible Time Interval

In the preceding discussion, reference is made to some interval of time over which handover measurements can be accumulated for processing. The length of this interval will naturally be a key determinant in the degree of improvement that can be achieved, a longer time interval encompassing a greater number of measurements. Ideally as long an interval as possible is desirable however in practice, an effective interval is imposed. The limit on the interval arises from non-synchronised BTS clocks since the RTD between any pair of BTS will vary or drift over time. The maximum rate of drift for RTDs in a standards compliant GSM network is 30 m/s, based on the frequency accuracy requirement of 0.005 ppm for a BTS. Given a target level of accuracy for the resulting RTDs therefore the maximum time interval over which measurements can be combined can be calculated. If a target of 200 m is issued, neglecting quantisation and other errors, the effect of drift alone would mean that an interval of not longer than 200/30=6.67 seconds could be used. In practice however the drift rates are likely to be lower than the limit of 30 m/s. Assuming for instance, a relative drift rate of 5 m/s, a time interval of the order of 200/5=40 seconds is possible.

### Taking Advantage of BTS Clock Drift

A further innovation here is the use of a filter to perform the combination. This is instead of batching the measurements for a single calculation. The individual measurements are applied to the filter as they are reported and the filter not only performs the averaging but also estimates the rate of drift which in turn determines the time constant of the filter or in other words the effective averaging time interval, thereby enabling the greatest averaging gain while limiting errors due to drift.

If the clocks in the network were perfectly stable, that is the clocks at each of the BTSs did not drift relative to each other, then one could average the RTD observations indefinitely, using for example, the recursive formula (4) referred to previously, to continue to improve the estimate. Theoretically this process would improve indefinitely.

In practice however, the BTS clocks are drifting with respect to each other as described above. In GSM the maximum permissible absolute drift rate for a BTS clock is specified at 0.05 ppm corresponding to a drift rate of 15 m/s. The clocks rarely operate this close to the limit. The effect of drift may be seen via the following example. Assume that the relative drift rate between two BTSs is constant at 5 m/s. If we average measurements obtained over a one minute interval, then from the start of the interval to the end, the RTD being estimated will have changed by 300 m. The effect of using a simple average will be an error of 150 m. Also if that estimate is then used for the next minute while more measurements are collected, then the estimate will be in error by 450 m by the end of that interval. If the drift were known, then this could be compensated for during the averaging process to improve the estimate and also to compensate for it over time so that the accuracy of the estimate does not degrade over time. Note it is only OTDs that are affected by drift. TA measurements are not affected by drift as these are basically a range measurement between the BTS and the mobile.

Clearly then, relative drift between a given pair of BTS clocks is a source of error. The drift limits the time interval over which it is useful to average RTD measurements. A number of solutions to this are proposed:

i) use a simple average but limit the time interval over which the averaging is done. This will however result in a lower accuracy.
ii) use a filter that “ages” the data such that the older the data being averaged the less weight it is given in the averaging process. The effect of drift is to make measurements degrade. The older the measurement, the less accurate it is due to drift. An example implementation is an exponential filter.

RTDᵢⱼ′(k)=αRTDᵢⱼ(k)+(1−α)RTDᵢⱼ′(k−1) (5)

The larger α, the less the averaging. If α=1, then the estimate is simply the latest estimate.

iii) use a Kalman filter. This filter can be used in a number of ways. It could be set up to use the RTD observations to estimate the RTD and the rate of change of the RTD thus resolving the problem of errors due to drift. Alternatively it could be used just to estimate the RTD but there is an aspect of the filter that enables it to “age” the data. In essence the filter adapts to the quality of the data via two parameters; the quality of the raw measurements and the quality of the underlying process, in this case the stability of the BTS clocks.

The foregoing discussion of the limiting effects of drift leads to another means of accuracy improvement. Since the OTD quantisation is a function of the true RTD, the relative propagation distances and the quantisation boundaries, it has been discussed that drift serves a useful purpose in actually varying the position of the measured OTD relative to the quantisation boundaries. As a result, in similar fashion to the benefit of having OTDs reported from different geographical positions, having OTDs measured from similar positions but at different instants will enable a filter that takes into account the time varying nature of the OTDs to more accurately measure the underlying RTD.

### Handover Based Synchronisation Using OTD and Estimated Handset Position

An alternative method of deriving the RTDs between BTSs will now be described.

Once again the basis is the handover during which the mobile reports the OTD to the network. In this case, rather than using the TAs measured by the original and final BTSs to isolate the clock offset contribution to the OTD from the positional component, an estimated position for the handset is used. The RTD is estimated as follows:

RTDᵢⱼ=OTDᵢⱼ−dᵢ+dⱼ (6)

Where dᵢ=∥bᵢ−ms∥ is the estimated range between the mobile and the base station based on the estimated handset position.

The estimate of the handset's position may arise from a variety of sources including:
A simple cell ID type position estimate. This would be useful for instance in urban areas where the cell sizes are relatively small and therefore the error in the range between mobile and BTS derived from the cell ID position estimate is likely to be significantly smaller than the error in the associated TA, in particular when the mobile is served by a micro-cell or pico-cell.
A more sophisticated position calculation such as a TA+NMR method, yielding greater accuracy in the derived ranges than a basic CID estimate.
A GPS or A-GPS equipped terminal. Handset populations in current networks are increasingly diverse with a range of handsets from early, minimal capability to newer high-end models incorporating devices such as GPS receivers. It is likely that operators offering LBS will be servicing a range of customers. Some customers, particularly those subscribing to services requiring high accuracy will likely have phones with a GPS capability. On the other hand there will undoubtedly be the more cost conscious customers using basic handset models. The present aspect enables such operators to leverage the population of high-end handsets to offer a better level of service to the remainder of their customers. During handover the OTD measured by the handset together with a recent GPS fix can be supplied to the positioning server enabling a significantly more accurate estimate of the RTD.

### Iterative Approach

Yet another approach is feasible to achieve an improved level of synchronisation between BTSs. In this case the handover measurement is used together with any additional available information from the handset that would aid in the position computation. The handset position is initially estimated using the current RTDs held by the server. This estimated position is then used to estimate the RTD. The RTD is applied to the filter and the updated RTD from the filter is once again used to estimate the handset position. The process can be repeated again however there will be diminishing returns. At start-up, rather than using the RTD held by the system as part of the position solution, the solution would be calculated using TA+NMR only. Typically only a single update cycle would be conducted, providing a more accurate RTD measurement for incorporation into the overall synchronisation model.

The equations describing this process are as follows:

$$G T {D}_{ij} ( m ) = O T {D}_{ij} - R T {D}_{ij}^{′} ( m - 1 ) \\ ( {x}^{)} ( m ) , {y}^{)} ( m ) ) = f ( G T {D}_{ij} ( m ) , {TA}_{i} , {TA}_{j} , NMR , … ) \\ {d}_{i} ( m ) = {( {( {x}^{)} ( m ) - {x}_{i} )}^{2} + {( {y}^{)} ( m ) - {y}_{i} )}^{2} )}^{\frac{1}{2}} \\ {d}_{j} ( m ) = {( {( {x}^{)} ( m ) - {x}_{j} )}^{2} + {( {y}^{)} ( m ) - {y}_{j} )}^{2} )}^{\frac{1}{2}} \\ R T {D}_{ij} ( m ) = O T {D}_{ij} - {d}_{i} ( m ) + {d}_{j} ( m ) \\ R T {D}^{′} ( m ) = g ( R T {D}_{ij} ( m ) , R T {D}_{ij} ) \qquad ( 7 )$$

where
m is the number of the iteration starting from m=1
RTDᵢⱼ′(m) is the current best estimate of the RTD between BTSᵢ and BTSⱼ
RTDᵢⱼ′(0) is the estimate of the RTD prior to incorporating the OTD. (If there is no prior estimate of the RTD then the GTD cannot be calculated and the mobile position estimate would not be able to include the GTD constraint.)
( [symbol] (m), [symbol] (m)) is the estimate of the handset's position
ƒ( ) is the function that determines the best estimate of position based on the information available
g( ) is the RTD averaging filter that generates the best estimate of the RTD based on the current RTD observation and all previous RTD measurements denoted by the vector (RTD).

The sequence of equations can be repeated through multiple iterations starting from m=1. Most of the improvement will derive from the initial iteration.

Synchronisation Using OTDs Reported by Handsets, Apart from Handovers

In this section an alternative approach is described that does not rely on the handover process. The advantage of this approach is that measurements can be obtained as required rather than only when a handover takes place. The basis of the RTD measurement is OTDs measured and reported by handsets. This could be for instance E-OTD equipped GSM handsets or alternatively 3 G UMTS handsets reporting SFN type 1 or 2 offsets.

Conventionally in E-OTD and OTDOA, the OTDs are used to determine the handset position not the RTD. In fact in both these systems, an additional element of network equipment, known as an LMU is deployed at multiple sites throughout the network at precisely surveyed positions to measure OTDs and enable RTDs to be derived. As noted earlier, the deployment and maintenance of these LMUs is a significant burden that operators have in the main been unwilling to bear. The advantage obtained by this further aspect of the invention is to leverage all such handsets as LMUs, using an alternative albeit lower accuracy position estimate based on CID type methods for instance to obtain less accurate estimates of the RTDs but then to combine these measurements thereby reducing the RTD errors to a useful level. It should be noted that in GSM, only a proportion of the handsets in a network are likely to be E-OTD capable and therefore the number of measurements available for averaging is likely to be smaller than for instance in UMTS where all handsets report offsets as part of their normal operation.

U.S. Pat. No. 6,529,165, to Brice et al. describes a method, known as “Matrix”, where the RTDs are estimated without LMUs. In this prior art method, the position of the handset as well as the timing offsets between the base stations are estimated jointly. The advantages of the present approach over the prior art is that there is a minimum number of handsets and BTSs reported in common required for the Matrix system to be operable. The second of these requirements is likely to be a significant limitation for this method in 3 G CDMA networks because the near-far effect in the common frequency channel significantly reduces the number of BTSs that a given handset can detect compared to a more spectrally diverse system such as GSM. By contrast, the present method can utilise one of a large number of techniques to estimate the handset's position without any direct dependency on other handsets. Although the accuracy of the initial RTDs from this method are likely to be poorer, averaging across measurements from the entire handset base will enable the errors to be reduced to an acceptable level.

Improving Synchronisation Accuracy by Combining Measurements from Co-Sited (Synchronised) Sectors

Considering the entire network of BTSs, one can envisage the RTDs between pairwise BTSs as a network where the vertices represent the BTSs and edges between any pair of vertices represent an estimate of the RTD between the corresponding BTSs. An important consideration applies when using RTDs for positioning, namely the so-called connectivity of the RTD network. It will be evident to readers familiar with cellular networks that there will not be direct RTD measurements between all pairwise combinations of BTSs in the network as handovers typically occur between relatively closely situated BTSs. Therefore physically close BTSs are more likely to be involved in handovers than BTS pairs with greater separation.

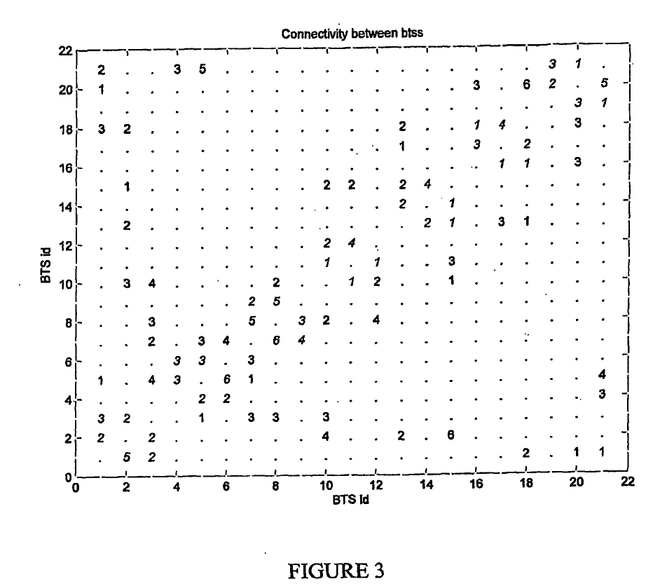

FIG. 3 illustrates the connectivity between BTSs using the simulation model described above in one simulated interval. The number in the ᵢth row and the ⱼth column represents the number of handovers that occurred from the ᵢth BTS to the ⱼth.

The fact that a full matrix is not presented means that the handovers from A to B have not been grouped with those from B to A although in theory one could average these by negating one or other set. Overall the results show that there are indeed multiple observations available in most cases for averaging however the numbers are relatively low and typically would yield a reduction in the error by a factor between 1.5 and 2.5.

A further factor that can be leveraged to advantage is the fact that co-sited BTS or so-called sectors of a site frequently derive their timing from a sector of an adjacent site reducing the number of RTDs to be estimated and at the same time increasing the number of estimates available for averaging.

For any given pair of co-sited sectors, although it may be known from the construction of the network, the presence of a common time source can be determined by repeated observation of OTDs from handovers involving one or both of those sectors. A single OTD measurement from an intra-site handover between the two sectors concerned will provide a very strong indication of them being synchronised, with an OTD value close to zero. Any subsequent similar handovers also indicating an OTD close to zero would confirm the presence of a common clock source. Over time the derived RTDs from such handovers would not exhibit the gradual drifts that are observed with unsynchronised transmitters. The presence of a common source can also be inferred given a pair of handovers, one from each of the two co-sited sectors to a common sector from a remotely situated site. In this case the RTDs calculated from those handovers would be the same (within the limits of the associated measurement and rounding errors and adjustment for drifts that may have occurred in the interval between the two handovers). Once again, whilst a single pair of such handover OTDs would provide strong evidence for synchronisation, a more robust implementation would seek additional reports also indicating synchronisation between the co-sited sectors before treating the sectors as synchronised in its processing.

As an example of the greater effects of averaging, given the knowledge that sectors are synchronised, consider the following.

Consider the handovers between two cell sites where the sectors at each of these sites are synchronised. Let the cell IDs at site 1 be 1, 2, and 3. The cell IDs at site 2 are 4, 5, and 6. In the measurement interval there are nᵢⱼ handover observations from cell i to cell j. If the cells were not synchronised the, for example, estimate of the RTD between cells i and j, denoted RTDᵢⱼ′ is

$$R T {D}_{ij}^{′} = - R T {D}_{ji}^{′} = \frac{1}{{n}_{ij} + {n}_{ji}} [ {\sum }_{k = 1}^{{n}_{ij}} R T {D}_{ij} ( k ) + {\sum }_{k = 1}^{{n}_{ji}} - R T {D}_{ji} ( k ) ] \qquad ( 8 )$$

The averaging process is taking into account the symmetry in RTDs whereby RTDᵢⱼ=−RTDⱼᵢ. Now if the cells are synchronised, the averaging process is not cell to cell but site to site.

The formulation is essentially the same, only with ⅓ fewer RTDs to estimate but each estimation has three times as much data to average and hence a more accurate estimate is obtained:

$$R T {D}_{ab}^{′} = - R T {D}_{ba}^{′} = \frac{1}{{n}_{ab} + {n}_{ba}} [ \begin{matrix}{\sum }_{k = 1}^{{n}_{ab}} R T {D}_{ab} ( k ) + \\ {\sum }_{k = 1}^{{n}_{ba}} - R T {D}_{ba} ( k )\end{matrix} ] \qquad ( 9 )$$

where a and b are used to denote the site rather than the sector. Any handover from a sector on site a to a sector on site b would give rise to an RTD_{ab} measurement that would feed into the averaging process.

It will be noted that for collocated synchronised sectors, there is no benefit gained from the averaging process as the RTDs in this case is 0. The sector to sector handovers, however, are used to check that the cells are still synchronised. This is discussed further below.

It will also be appreciated that the above process has an equivalent formulation for any other averaging process such as a filter.

As will be understood by the person skilled in the art, there are many techniques for establishing whether the sectors of a base station are synchronised. Some techniques have been previously discussed in the present application and are now elaborated upon for further clarification.

The synchronisation between sectors is an artefact of the manner in which the BTS is constructed. Hence the information may be available from the network operator.

Whenever there is a handover from one sector to another, the OTD is measured and reported. If the handover is between two collocated sectors then the OTD can be used to indicate synchronisation. If the sectors are synchronised, then the OTD ideally will be zero. In practice, the OTD will be near zero due to propagation and quantisation effects. Consistently reported near-zero OTDs would indicate synchronised sectors. A possible implementation of this would be to observe the OTDs for an hour and count the near-zero OTDs for sector-to-sector handovers. If a given pair of sectors are synchronised, the ratio of near-zero OTDs to not near-zero OTDs would be expected to be quite large. If the ratio is above a threshold, then the sectors are synchronised. Experimental analysis would be used to specify the threshold and minimum number of observations required, as would be understood by the person skilled in the art.

It is possible that changes to the network can make some sectors become unsynchronised. Generally this would be known in advance since, as described above, the synchronisation is due to the manner the network is constructed. If sectors do become unsynchronised, this can be detected automatically and the synchronisation constraint relaxed accordingly. One implementation is to continuously monitor the network using the technique described above. Another implementation is to formulate the network of RTDs as a set of linear, simultaneous equations. If any of the assumed sectors are no longer synchronised, this would become evident through large errors (residuals) arising in the solution of the simultaneous equations.

Note that if two sectors at a site are synchronised and one is not, one would only combine the measurements relating to the two synchronised sectors (cells) and leave the unsynchronised cell alone.

Having used site-to-site RTD estimates, the cell-to-cell RTDs are easily obtained by simply looking up the associated site-to-site RTD for the cells involved.

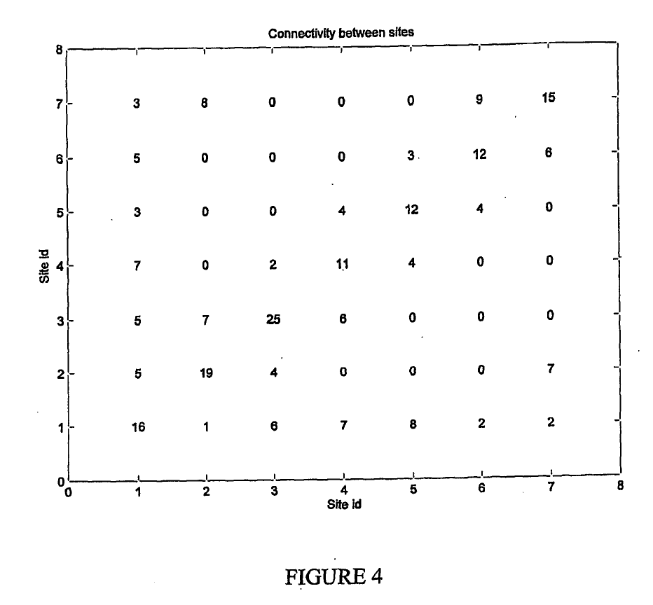

FIG. 4 illustrates the connectivity between all pairs of sites in the network. In this case the number of estimates has increased significantly leading to averaging gains typically in the range from 2 to 5. In practice the use of a Kalman Filter to optimise the averaging interval will yield significantly greater error reduction.

### Use of the Handover Measurements and RTDS for Improved Positioning

There are a number of references both in the open literature as well as patents that describe methods for positioning mobile terminals using existing measurements such as TA and signal strength. PCT Patent Application No. PCT/SE01/02679 (WO 02/47421) describes a system for positioning mobile terminals using the timing advance as well as the received signal level measurements. A desirable aspect of such methods is that they provide greater accuracy than basic CID without requiring any handset alterations or expensive network infrastructure deployments. In this section there is described how an additional element can be added to improve the accuracy of such systems yielding a significant accuracy improvement whilst still obviating any need for handset alterations or expensive network infrastructure deployments.

As noted earlier, when concluding a handover, the handset reports an OTD value to the network. If the RTD between the associated BTSs is known, this component of the OTD can be eliminated yielding what is often referred to as the Geometric Time Difference (GTD) which proscribes a hyperbolic locus of possible positions for the handset. In combination with the circular loci associated with the two TA measurements and the positional constraints represented by the received signal levels, this hyperbolic constraint provides a significant enhancement to the positional accuracy. Compared with the other measurements that are available in a GSM network without alteration to a handset, the OTD represents the most precise measurement.

Each measurement made by the handset forms a constraint on the location of that handset. TA measurements can be converted to a range, albeit quantised to the nearest 550 m. In essence the handset is constrained to lie on an annulus 550 m wide centred on the base station with a mean radius defined by the TA measurement. Similarly the received power levels and directional nature of the BTS antennas further constrain the location of the mobile. These constraints can be modelled, the measurements added to the model and mathematical optimisation applied to derive the best estimate of the handset's position. This aspect of the invention refers to adding the GTD derived from the OTD measurement and RTD estimate.

The observed time difference between a signal arriving from base station i and base station j comprises two components. A component due to the difference of signal departure time referred to as the RTD and a component due to the difference in distances from the mobile to base station i and the mobile to base station j. This is referred to as the geometric time difference GTD. If there is an estimate of the RTD then an estimate of the GTD can be computed.

GTDᵢⱼ=OTDᵢⱼ−RTDᵢⱼ′ (10)

Hence the GTD constrains the mobile to lie somewhere on a hyperbolic locus. The hyperbola has two halves. Upon which half of the hyperbola the mobile lies is defined by the sign of the GTD.

$$G T {D}_{ij} = {( {( x - {x}_{i} )}^{2} + {( y - {y}_{i} )}^{2} )}^{\frac{1}{2}} - {( {( x - {x}_{j} )}^{2} + {( y - {y}_{j} )}^{2} )}^{\frac{1}{2}} \qquad ( 11 )$$

This constraint can be combined with other constraints to produce a set of equations that define the position of the mobile. Various algorithms well-known in the art can be used to find a numerical solution to the problem and thus an estimate of the position of the mobile. The key step in this aspect of the invention is the use of the GTD as an additional constraint for estimating location. This step is enabled by the process used to generate an estimate of the RTD.

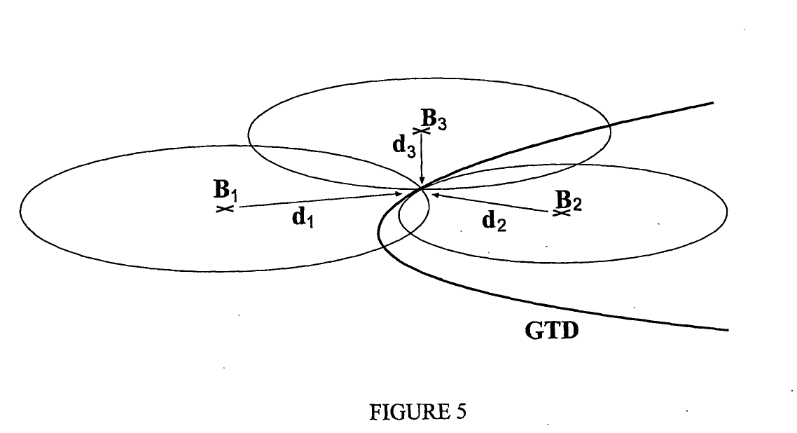

FIG. 5 illustrates an example of these considerations. In FIG. 5, B₁, B₂ and B₃ are base transmitting stations in respective sectors, d₁, d₂ and d₃ are the respective ranges from the base stations to the mobile, derived by any suitable means such as TA, and GTD is the hyperbola between BTS₁ and BTS₂.

The benefit of the additional handover derived OTD measurement is most marked in larger cell sizes characteristic of suburban and rural areas where the path loss characteristic of the signal propagation makes the received signal levels a fairly loose positional constraint. Furthermore in such environments, the accuracy of the timing measurements is subject to relatively low time dispersion and the errors therefore arise mostly from the OTD rounding to the nearest half bit.

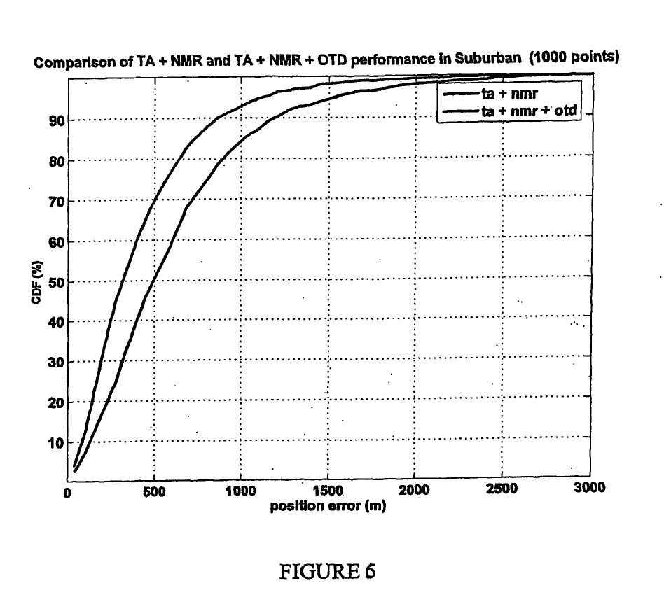

FIG. 6 illustrates the degree of improvement that can be gained from the use of an OTD. The plots show the cumulative distribution of the position error for simulations of a suburban network. 1000 random position measurements were simulated. For each a simulated set of received signal levels, TAs and a single OTD measurement were generated. The simulation models the various processes and phenomena giving rise to the measurement errors in detail. This is the case both for the received signal level measurements which in GSM represent the average of multiple observations over a 480 millisecond interval as well as for the TA and OTDs in which the time dispersion in the network as well as the effect of noise and interference and finally the rounding are modelled. In terms of the common 67^{th} percentile accuracy measure, the effect of the OTD is to reduce the error by 30 percent whilst at the 95^{th} percentile the improvement for this set of data was 27 percent.

While the above has been described with reference to a number of preferred embodiments, it will be understood that many variations and modifications may be made within the scope of the inventions detailed herein.

It will also be appreciated that while the emphasis of the present inventions are described in the context of network elements being Base Transmitting Stations (BTS), it will be understood that the inventions are equally applicable to other suitable network elements such as for example, Location Measurement Units (LMUs), where applicable.

Furthermore, it will be appreciated that certain GSM-specific terms such as Timing Advance (TA) and Observed Time Difference (OTD) are used in this specification for corresponding parameters, however, it will be appreciated that these parameters have equivalent parameters in other systems which may be referred to by other terms. The scope of the present invention is not be limited to the specific term itself.

1. A method of determining a Real Time Difference (RTD) between respective clocks of a first network element and a second network element in a communications network, the method comprising:
measuring at least one parameter resulting from a first handover of a first mobile unit from the first network element to the second network element to provide a first measurement set;
measuring the at least one parameter resulting from a handover of at least one further mobile unit between the first network element and the second network element to provide a further measurement set; and
processing the first and further measurement sets to provide an estimate of a common RTD.

2. A method according to claim 1, wherein the first mobile unit and the further mobile unit are at different positions within the communications network.

3. A method according to claim 1 wherein the at least one parameter is an Observed Time Difference (OTD) and/or a Timing Advance (TA).

4. A method according to claim 1 wherein the first network element and the second network element are base transmitting stations (BTS).

5. A method according to claim 1 wherein the first and further measurement sets are processed by averaging.

6. A method according to claim 5 wherein the step of averaging comprises filtering the first and further measurement sets according to the formula:
$$R T {D}_{ij}^{′} = \frac{1}{n} {\sum }_{k = 1}^{n} R T {D}_{ij} ( k )$$
where RTD′ᵢⱼ is the estimate of the common RTD obtained by taking the numerical average of the previous n common RTD measurements denoted RTDᵢⱼ(k) and where i=an i^{th} sector, j=a j^{th} sector.

7. A method according to claim 6 wherein the step of averaging comprises filtering the first and further measurement sets according to the recursive formula:
$$R T {D}_{ij}^{′} ( k ) = \frac{1}{k} ( R T {D}_{ij} ( k ) + ( k - 1 ) R T {D}_{ij}^{′} ( k - 1 ) )$$

8. A method according to claim 1 wherein measurements of the at least one parameter from handovers occurring between co-sited sectors are analysed to determine whether the co-sited sectors derive their timing from a common source.

9. A method according to claim 8 wherein the measurements from the handovers occurring between co-sited sectors which have been determined to derive their timing from a common source are processed to provide the common RTD.

10. A method according to claim 5 wherein the step of averaging is performed by use of a filter having a time constant.

11. A method according to claim 10 wherein the time constant of the filter is determined by a rate of drift of a clock of the first or second network element.

12. A method according to claim 10 wherein the filter is a Kalman filter.

13. A method of averaging a plurality of RTD measurements taken in respect of a communications network clocked element which experiences clock drift, the method comprising:
averaging the plurality of RTD measurements over a given period of time.

14. A method according to claim 13, wherein the given period of time is determined by a rate of the clock drift of the clocked element.

15. A method according to claim 14 wherein the plurality of RTD measurements is averaged by use of a filter having a time constant.

16. A method according to claim 15 wherein the time constant of the filter is proportional to the rate of clock drift.

17. A method according to claim 16 wherein the time constant is proportional to a maximum tolerable synchronisation error divided by the differential clock drift between the clocked element and that of a second clocked element in the network.

18. A method according to claim 13 wherein RTD measurements taken towards the beginning of the given period of time are given progressively less weighting than RTD measurements taken towards the end of the given period of time.

19. A method according to claim 18 wherein the filter is an exponential filter operating according to the following formula:
RTD′ᵢⱼ(k)=αRTDᵢⱼ(k)+(1−α)RTD′ᵢⱼ(k−1)
where
RTD′ᵢⱼ(k) is the filtered estimate of the RTD between BTSᵢ and BTSⱼ at time k
RTDᵢⱼ(k) is the computed RTD between BTSᵢ and BTSⱼ at time k and α is the filter parameter determining the time constant of the filter.

20. A method according to claim 13 wherein the averaging is performed by a Kalman filter.

21. A method of calculating a real time difference (RTD) between respective clocks of a first network element and a second network element within a radio communications network, the method comprising;
estimating a position of a mobile element within the network to provide an estimated mobile element position;
calculating a distance (d₁) between the first network element and the estimated mobile element position;
calculating a distance (d₂) between the second network element and the estimated mobile element position;
measuring an Observed Time Difference (OTD_{1,2}) between the respective clocks of the first and second network elements; and
calculating the RTD according to the following formula:
RTD_{1,2}=OTD_{1,2}−d₁+d₂

22. A method according to claim 21 wherein the step of estimating the position of the mobile element is performed using Cell ID.

23. A method according to claim 21 wherein the step of estimating the position of the mobile element is performed using a Global Positioning System (GPS).

24. A method according to claim 21 wherein the network elements are Base Transmitting Stations (BTS) and the mobile element is a mobile telephone handset.

25. A method of calculating a Real Time Difference (RTD) between respective clocks of a first network element and a second network element within a radio communications network, the method including;
estimating a position of a mobile element handing over from the first network element to the second network element, using a current value of the RTD found by the network;
estimating a subsequent RTD using the estimated position of the mobile element;
processing the subsequent RTD according to the first aspect of the present invention and using the processed subsequent RTD to again estimate the position of the mobile element; and
repeating the process for as many cycles as is required.

26. A method according to claim 25 wherein the initial RTD value used is calculated using the estimated position of the mobile element derived from Timing Advance plus NMR values in place of the current RTD held by the network.

27. A method for determining a position of a mobile unit within a mobile radio communications network, the method including the use of an Observed Time Difference (OTD) in conjunction with two or more time of arrivals (TA) and a current RTD held by the network to derive a Geometric Time Difference (GTD) describing a hyperbolic locus of position.

28. A method of estimating a position of a mobile unit between two network elements within a radio communications network, the method including:
measuring signal strength at the mobile unit to provide a first measurement;
obtaining a Timing Advance measurement at the mobile unit to provide a second measurement;
measuring an Observed Time Difference (OTD) between the two network elements at the mobile unit to provide a third measurement; and
combining and processing the three measurements to obtain an estimate of the position of the mobile unit.

29. A method according to claim 28 wherein the OTD is obtained as the mobile unit is handing over from a first to a second of the two network elements.

30. A method according to claim 28 wherein the network elements are BTSs.
